(19) United States
(12) Patent Application Publication
(10) Pub. No.: US 2023/0127096 A1
(43) Pub. Date: Apr. 27, 2023

(54) ICE DRILL HANDLE ATTACHMENT ASSEMBLY AND ICE DRILL CONTAINING SAID ASSEMBLY

(71) Applicant: Aleksandr Vasilevich SERDIUKOV, Barnaul (RU)

(72) Inventors: Evgenii Viktorovich ILCHENKO, Barnaul (RU); Viacheslav Mikhailovich KRYMOV, Barnaul (RU)

(21) Appl. No.: 17/721,901

(22) Filed: Apr. 15, 2022

(30) Foreign Application Priority Data
Jun. 28, 2021 (RU) 2021118703

(51) Int. Cl. E21B 7/00; B25G 3/38

(52) U.S. Cl. CPC E21B 7/008; B25G 3/38; A01K 97/01

(57) ABSTRACT

An ice auger handle attachment assembly that includes a first bushing with a recess on the end side for a first pin of a handle, a second bushing with two symmetrical flat side surfaces made on the part of the length of the second bushing and having arcuate recesses that form stops. The second bushing partially covers the first bushing and is attached thereto by means of a stud fixed on the end of the handle. Further, a blocking element and the second pin pass through a slot in the second bushing and a hole in the stud. A spring is mounted on the stud between the first and second bushings, and a fork-shaped lever covering the second bushing in the area of the flat side surfaces and hinged thereon by means of the second pin.

The technical solution relates to accessories for ice fishing, namely ice augers, and is used for drilling holes in the ice for fishing, but can also be used to make holes in the ice for other purposes.

An ice auger according to the patent of the Russian Federation No. 2483536 (IPC A01K 97/01, B25G 3/38, F25C 5/02, published Oct. 6, 2013) is known comprising a drill rod (auger conveyor) with a drilling and cutting head mounted on its lower end, and a handle with a locking pin attached thereto. The handle is installed in a bushing mounted perpendicular to the auger conveyor axis and can be in the unfolded working position or folded transport position. The transfer of the handle from one position to another is carried out by means of a cam mechanism, which is pressed and controlled by a movable element, by means of a spring element (butterfly screw), to move from one position to another and back again.

The handle attachment assembly of the known ice auger has a complex design and low reliability of the cam mechanism associated with abrasion of surfaces and changes in geometry resulting in appearance of backlash, unreliable fixation of the elements in the required position, and the likelihood of unfixing the mechanism. In addition, the position of the movable element (butterfly screw) can be accidentally changed during operation, when caught in winter clothing in the process of drilling holes.

As the closest analogue, an ice auger was chosen according to the patent of the Russian Federation No. 2647503 (IPC A01K 97/00, published Mar. 16, 2018), which comprises a handle attachment assembly including a first bushing (sleeve bearing) with a recess on the end side for a first handle pin, a second bushing with two symmetrical flat side surfaces made for part of the length of the second bushing and having arcuate recesses that form stops, wherein the second bushing partially covers the first bushing and is connected thereto by means of a stud fixed to the end of the handle, a nut, and a second pin passing through a slot in the second bushing and a hole in the stud, a spring mounted on the stud between the first and second bushings, and a fork-shaped lever enclosing the second bushing in the area of the flat side surfaces and hinged thereto by means of the second pin. The fork-shaped lever in the area of fastening with the second pin has a curved surface with mating sections of different radii, with the possibility of alternate alignment of said sections with the arcuate recesses made on the symmetrical flat side surfaces.

If the parts of the known ice auger handle attachment assembly, which provide attachment to the auger conveyor, are made of plastic or other polymeric materials, then over time, during use, the rubbing parts wear out, a backlash of the parts appears, and the reliability of fixing the parts of the ice auger in the selected position decreases. In order to avoid abrasion of the rubbing surfaces and violation of the geometry of parts that results in the appearance of backlash, unreliable fixation of elements in the required position, and decrease in the reliability of the cam mechanism, it is advisable to make said parts from metal. However, fully metallic parts are characterized by high weight, high material consumption, manufacturing complexity, and in addition, the use of the ice auger with metallic parts at low temperatures can cause discomfort for the user.

In contrast to the known solutions, it is proposed to make from metal only those elements of the handle attachment assembly that are subject to friction when transferring the handle from the transport position to the working position and back again during operation.

The technical result achieved in this case is to increase the reliability of the handle attachment assembly in comparison with similar mechanisms made of other materials, and also to increase the usability and ease of manufacture in comparison with assemblies comprising fully metallic parts.

The claimed technical result is achieved by the fact that in the ice auger handle attachment assembly, which comprises the first bushing, the second bushing with two symmetrical flat side surfaces that partially covers the first bushing and is connected thereto, the inner surface of the second bushing has a metallic section. The first bushing is made with a recess on the end side for the first pin of the handle, the symmetrical flat side surfaces of the second bushing are made for part of its length and have arcuate recesses that form stops. The second bushing is connected to the first bushing by means of a stud fixed on the end of the handle, a blocking element, and a second pin passing through a slot in the second bushing and a hole in the stud, and a spring mounted on the stud between the first and second bushings. In the area of the flat side surfaces of the second bushing, a fork-shaped lever is installed, covering the second bushing and hinged thereto by means of a second pin, wherein the fork-shaped lever has a cam surface with curved mating sections of different radii in the area of fastening with the second pin, with the possibility of variable alignment of said sections with the arcuate recesses made on the symmetrical flat side surfaces. The slot for the second pin in the second bushing is made of an elongated oval shape, being oriented along the axis of the bushing, and the metallic section of the inner surface of the second bushing is made with an element that prevents longitudinal shift and rotation of the said section relative to the axis of the bushing, which element can be made, in particular, in the form of a protrusion or recess. The fork-shaped lever can be made of metal and at least partially comprise a shell of a polymeric material.

The claimed ice auger comprises a handle and an auger conveyor, a helical screw blade made on the auger conveyor from its lower end to the middle part, a drill head attached to the auger conveyor at its lower end, and at least one cutting blade fixed to the drill head, wherein the handle is movably attached to the auger conveyor by means of the claimed attachment assembly. The drill head can be attached to the auger conveyor at its lower end either by a detachable connection or a permanent connection.

The technical solution is explained with reference to figures, which conditionally represent one of the possible embodiments. However, it should be understood that the present embodiment is provided solely as an example, which may be implemented in various forms. The figures are not necessarily drawn to scale, and some features may be enlarged or reduced in size to show parts of particular elements. The specific design and functional features set forth in this description should not be construed as limiting, and are given only as an illustrative example for the understanding of possible embodiments of the disclosed essence of the present technical solution by a person skilled in the art.

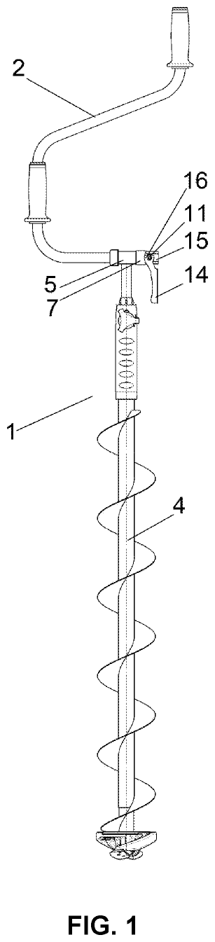

FIG. 1 schematically shows the ice auger with the handle attachment assembly in the working position.

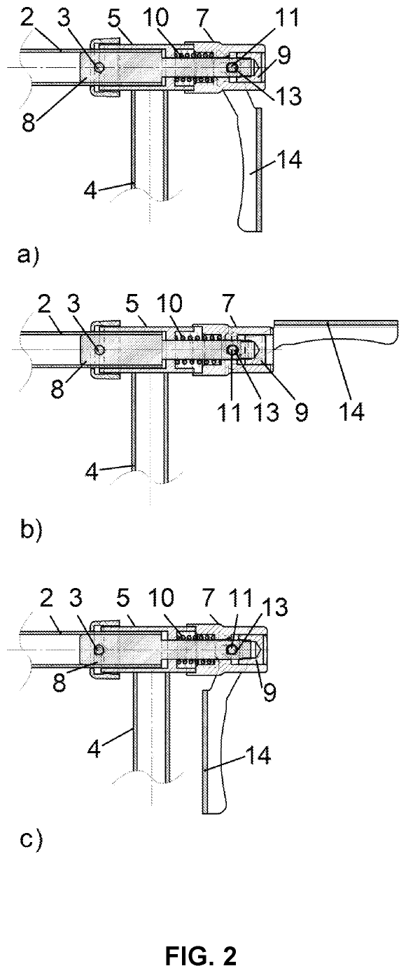

FIG. 2 shows the ice auger handle attachment assembly with the fork-shaped lever schematically in section: position a) is the position of the fork-shaped lever in the working condition of the ice auger, the fork-shaped lever is at the bottom; position b) is the neutral position of the fork-shaped lever provided for changing the position of the handle, the lever is horizontal; position c) is the position of the fork-shaped lever in the transport condition of the ice auger, the fork-shaped lever is at the bottom.

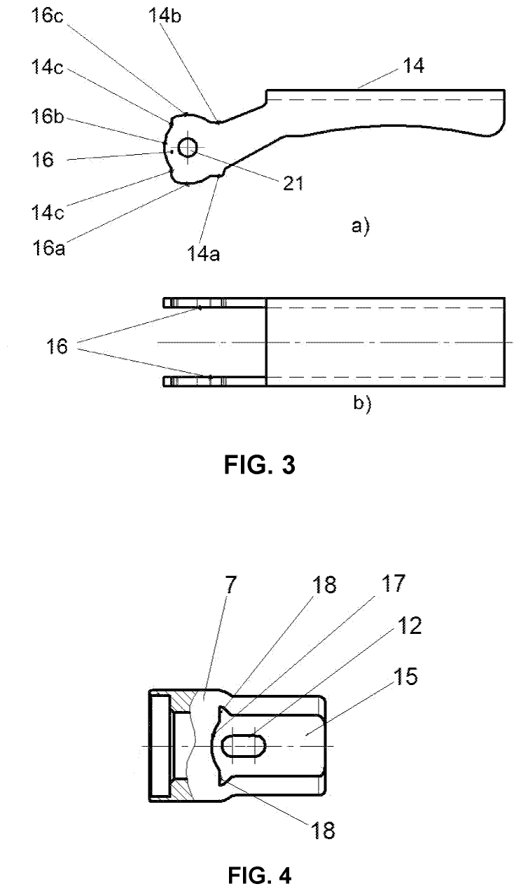

FIG. 3 schematically shows the fork-shaped lever: position a) is a side view; position b) is a top view.

FIG. 4 shows a partially sectioned side view of the second bushing showing one of the two symmetrical flat side surfaces.

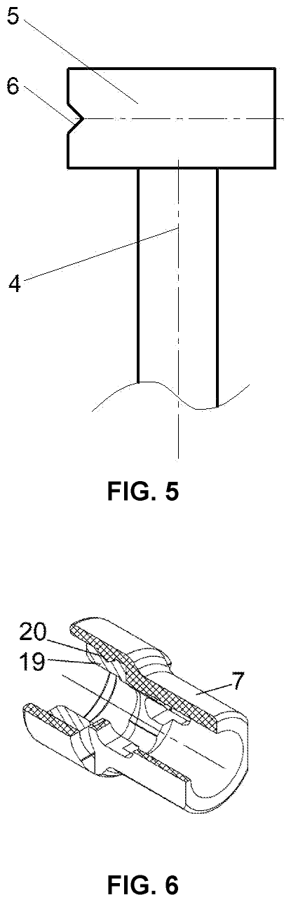

FIG. 5 shows the first bushing with the recess for the locking pin.

FIG. 6 shows a general view of the second bushing with a partial section.

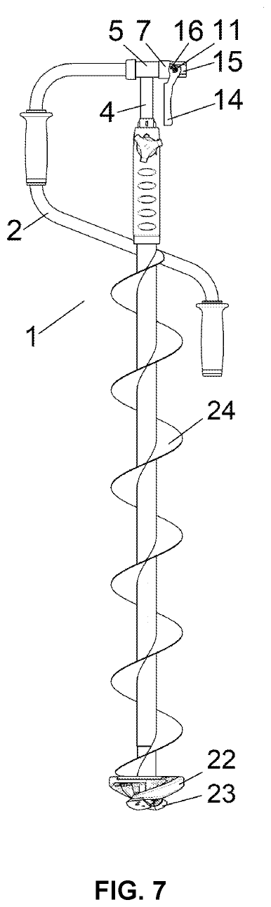

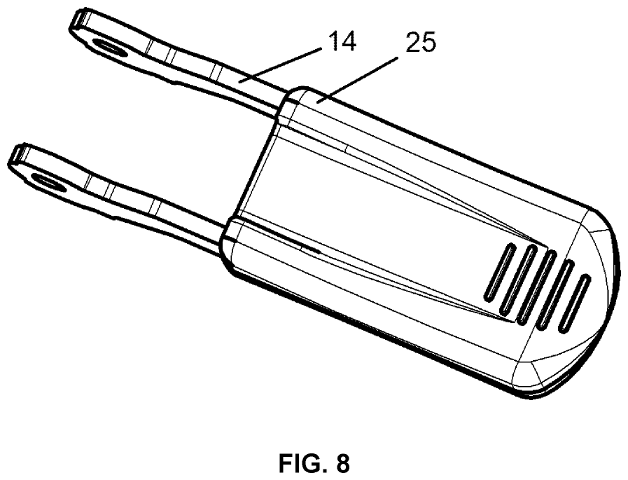

FIG. 7 schematically shows the ice auger with the handle attachment assembly in the transport position.

FIG. 8. schematically shows a general view of the fork-shaped lever with the shell.

The figures indicate: 1 is the ice auger, 2 is the handle, 3 is the first pin, 4 is the auger conveyor, 5 is the first bushing, 6 is the recess for the first pin (3), 7 is the second bushing, 8 is the stud, 9 is the blocking element, 10 is the spring, 11 is the second pin, 12 is the slot of the second bushing (7), 13 is the hole in the stud (8), 14 is the fork-shaped lever with the stops 14a, 14b, and 14c to limit the travel of the fork-shaped lever (14), 15 is the symmetrical flat side surfaces, 16 is the cam surface with the curved mating sections (16a, 16b, and 16c) of different radii, 17 are the arcuate recesses, 18 are the stops, 19 is the metallic section of the inner surface of the second bushing (7), 20 is the element that prevents longitudinal shift and rotation of the metallic section (19) of the second bushing (7), 21 is a hole in the fork-shaped lever (14) for the second pin (11), 22 is the drill head, 23 is the blade, 24 is the helical screw blade of the auger conveyor (4), 25 is the shell of the fork-shaped lever (14).

The ice auger handle attachment assembly (1) comprises the first bushing (5), the second bushing (7) partially covering the first bushing (5) and connected thereto by means of the stud (8) and the pin (11), the spring (10) mounted on the stud (8) between the first (5) and second (7) bushings, and the fork-shaped lever (14).

The first bushing (5) is installed perpendicular to the axis of the auger conveyor (4), has the recess (6) for the first pin (3), which pin can be closed from above with a decorative cap. The handle (2), on which the first pin (3) is fixed, is installed in the first bushing (5). The stud (8) is fixed at the end of the handle (2). The stud (8) may be secured by means of the pin (3) and/or a welded connection or in another manner providing a rigid connection. The second bushing (7) partially covers the first bushing (5) and is connected thereto by means of the stud (8), the second pin (11) passing through the slot (12) in the second bushing (7) and the hole (13) in the stud (8), and also the blocking element (9). In the figures, the blocking element (9) is presented in the form of a nut. However, another embodiment of this element is also possible, for example, in the form of a bolt fixed at the end of the stud (8) by screwing into the hole with an internal thread. The spring (10) is installed on the stud (8) between the first (5) and second (7) bushings. The second pin (11) can move in the slot (12), which allows transferring of the circular motion of the lever (14) into the translatory motion of the second bushing (7) due to the elongated shape of the slot (12), the interaction of the cam surface (16) of the fork-shaped lever (14) and the arcuate recesses (17) and stops (18) of the second bushing (7), and also due to the spring (10) compression and return.

The inner surface of the second bushing (7) has the metallic section (19), at least in those points where the elements of the handle attachment assembly (2) are subjected to loads, in particular, to the compression and rubbing when transferring the handle (2) from the transport position to the working position and back again during use of the ice auger. This allows to avoid abrasion of rubbing surfaces and violation of the geometry of parts resulting in the appearance of backlash, unreliable fixation of elements in the required position and reducing the reliability of the assembly operation. Preferably, the metallic section (19) of the inner surface of the second bushing (7) is made in the area of the arcuate recesses (17) and stops (18). It should be noted that the metallic section (19) of the inner surface of the second bushing (7) can be made not only in the area of the arcuate recesses (17) and stops (18), but also, for example, from the recesses (17) to the point of interaction with the spring (10), to avoid wear under the influence of metallic spring, or from the slot (12), to interact with the pin (11), as well as along the entire inner surface of the second bushing (7). The metallic section (19) of the inner surface of the second bushing (7) for reliable fastening with the body of the second bushing (7) itself can be made with an element (20) that prevents longitudinal shift and rotation of the said section relative to the bushing axis. Said element (20) can be made, in particular, in the form of one or more protrusions, or one or more recesses, both annular and radial, as shown in FIG. 6. The specified design of the second bushing (7) can be obtained, for example, by manufacturing a metallic part by casting or machining, which part is then covered with a layer of polymer material in a mold. This design provides the rigidity of those points in the handle attachment assembly (2) that are subjected to loads, in particular, to compression and rubbing during operation.

Two symmetrical flat side surfaces (15) are made on the outer surface of the second bushing. Said flat side surfaces (15) are made for part of the length of the second bushing (7) on the side of connection to the fork-shaped lever (14) in such a way that the slot (12), in which the pin (11) connecting the stud (8), the second bushing (7), and the fork-shaped lever (14) is placed, is made perpendicular to the plane of the surfaces (15) and passes through them. The flat side surfaces (15) on the side opposite to the end part of the second bushing (7) have the arcuate recesses (17) that form the stops (18).

The fork-shaped lever (14) has a cam surface (16) with curved mating sections (16a, 16b, and 16c) of different radii in the area of fastening with the second pin (11), with the possibility of alternate alignment of said sections (16a, 16b, and 16c) with the arcuate recesses (17) made on the symmetrical flat side surfaces (15). Section 16a has the largest radius from the center of the hole (21) of the fork-shaped lever (14), section 16b has the smallest radius, and section 16c has a radius in the range between those of 16a and 16b. Also, stops (14a, 14b, and 14c) are made on the fork-shaped lever (14) to limit its travel.

The fork-shaped lever (14) is also made of metal, at least the parts of the cam surface (16) and stops (14a, 14b, and 14c) interacting with the metallic section (19) of the inner surface of the second bushing (7) in the area of the arcuate recesses (17) and with the stops (18). In the area where the user interacts with the fork-shaped lever (14) during operation, the lever preferably comprises a shell (25) of polymeric material to increase comfort and reduce cold exposure from metallic parts.

The claimed ice auger (1) comprises an auger conveyor (4) and a handle (2) movably attached to the auger conveyor (4) by means of the claimed attachment assembly.

The handle (2) and auger conveyor (4) of the ice auger (1) can be made of metal or composite materials. For ease of use, the handle (2) and the auger conveyor (4) in the areas that are intended to be held by the user during use and/or transportation can be covered with plastic, rubber or polymeric materials.

The auger conveyor (4) can be rotated around its own axis for ice drilling by turning the winch (2). At the lower end of the auger conveyor (4) there is a drill head (22) fixedly attached to the auger conveyor (4) to rotate therewith when the auger conveyor (4) is driven in rotation. One or more cutting blades (23) are attached to the drill head (22) for ice drilling wherein the auger conveyor (4) with the drill head (22) is rotated. The helical blade (24) of the auger conveyor (4) is used to lift the crushed ice formed in the process of drilling up from the drill head (22).

The claimed invention is implemented as follows: the transfer of the handle (2) of the ice auger (1) from the transport position to the working position and back again is carried out by transferring the fork-shaped lever (14) to three sequentially connected positions.

Transport Position

To transfer the ice auger (1) into the transport position and fix therein, the fork-shaped lever (14) is transferred to the neutral position (see FIG. 2b, the lever is in a horizontal position), wherein the cam surface (16) interacts with the arcuate recesses (17) by its section (16b) of the smallest radius, the second pin (11) moves in the slot (12) towards the first bushing (5). The movement is limited by the mating of stops (14c) and shoulder-like stops (18) of the second bushing (7). The spring (10) is decompressed and the second bushing (7) moves axially, as a result of which moving a gap appears between the first bushing (5) and the second bushing (7), allowing the first pin (3) connected to the handle (2) to come out of the recess (6) of the first bushing (5) and release the axis of rotation to turn the handle (2). After turning the handle (2) into the transport position in a plane perpendicular to the axis of the bushings (5 and 7), it is fixed by turning the fork-shaped lever (14) (see FIG. 2c) down until the stop (14b) of the fork-shaped lever (14) is mated with the shoulder-like stop (18) of the second bushing (7). Since the handle (2) in the transport position, as a rule, does not rotate completely into the same plane with the auger conveyor (4) due to the restriction of the handle position by the auger conveyor (4), the recess (6) is made in such a shape and size that the first pin (3) fell into the said recess (6) when the fork-shaped lever (14) was moved down and the cam surface (16) interacted with the arcuate recesses (17) by its section (16c) of the average radius. As a result, the first pin (3) mounted on the handle (2) becomes loose in the recess (6) of the first bushing (5). The ice auger (1) is ready for transportation.

Working Position:

To fix the handle (2) of the ice auger (1) in the working position, the fork-shaped lever (14) is transferred to the neutral position (see FIG. 2b, the lever is in a horizontal position), wherein the cam surface (16) interacts with the arcuate recesses (17) by its section (16b) of the smallest radius, the second pin (11) moves in the slot (12) towards the first bushing (5). The movement is limited by the mating of stops (14c) and shoulder-like stops (18) of the second bushing (7). The spring (10) is decompressed and the second bushing (7) moves axially, as a result of which a gap appears between the first bushing (5) and the second bushing (7), allowing the first pin (3) connected to the handle (2) to come out of the recess (6) of the first bushing (5) and release the axis of rotation to turn the handle (2). After turning the handle (2) into the working position in a plane perpendicular to the axis of the bushings (5 and 7), it is fixed by turning the fork-shaped lever (14) (see FIG. 2a) down until the stop (14a) of the fork-shaped lever (14) is mated with the shoulder-like stop (18) of the second bushing (7). In this case, due to the rotation of the cam surface (16) located on the fork of the lever (14), and mating its section (16a) of the largest radius with the arcuate recesses (17), the second pin (11) moves in the slot (12) in the direction from the first bushing (5), the spring (10) is compressed and the second bushing (7) moves axially. As a result, the first pin (3), mounted on the handle (2), becomes rigidly closed in the recess (6) of the first bushing (5). The ice auger (1) is ready for use.

Since the fork-shaped lever (14) with the cam surface (16) translates the circular movement of the lever (14) into the translatory movement of the second bushing (7), the possibility of accidental, uncontrolled rotation and change of the position of the handle during the operation of the ice auger is excluded. This is explained by the fact that the process of operation of the ice auger (1) is carried out in a plane parallel to the axis of the second bushing (7), which prevents an accidental rotation of the lever (14), since it is necessary to turn and raise it purposefully in order to change its position, which movement cannot happen by accident.

When drilling holes in the ice, the ice auger works stably and evenly, since the second pin (11) passes not only through the slot (12) in the second bushing (7), but also through the hole (13) in the fixedly attached stud (8), the mechanism is more reliable and durable, being able to carry heavy loads. The proposed design is characterized by high reliability in comparison with known solutions, the appearance of backlash in it is essentially eliminated, since the parts of the mechanism that are subjected to loads during operation, when moving the handle (2) to the desired position, are made of metal, and the stops (14a, 14b, and 14c) on the fork-shaped lever (14) additionally play a role of locking elements that prevent any unplanned change of the position of the second bushing (7) relative to the first pin (3). The fork-shaped lever (14) is fixed not just by turning it, but initially by transferring it to another plane and only then by finally fixing it in the desired position in the stops (14a, 14b, and 14c) by means of the shoulder-like stops (18) made on the arcuate recesses (17) of the symmetrical flat side surfaces (15).

The use of metallic section only on the inner surface of the second bushing (7) allows to get reliable interaction and durability of the design of the handle attachment assembly, to improve ease of use, and to simplify manufacturing in comparison with assemblies having fully metallic parts.

The ice auger handle attachment assembly can be made by any method known in the art and used in the ice augers for drilling holes in the ice for fishing, as well as for making holes in the ice for other purposes. The presented figures and description of the design are not intended to be exhaustive embodiments and do not limit the scope of the proposed technical solution in any way. Other embodiments are possible within the scope of the claims of the invention.

1. An ice auger handle attachment assembly comprising a first bushing with a recess on the end side for a first pin of a handle, a second bushing with two symmetrical flat side surfaces made on the part of the length of the second bushing and having arcuate recesses that form stops, wherein the second bushing partially covers the first bushing and is attached thereto by means of a stud fixed on the end of the handle, a blocking element, and the second pin passing through a slot in the second bushing and a hole in the stud, a spring mounted on the stud between the first and second bushings, and a fork-shaped lever covering the second bushing in the area of the flat side surfaces and hinged thereon by means of the second pin, wherein the fork-shaped lever in the area of fastening with the second pin has a cam surface with curved mating sections of different radii, with the possibility of alternate alignment of said sections with the arcuate recesses made on the symmetrical flat side surfaces, wherein the inner surface of the second bushing has a metallic section.

2. The ice auger handle attachment assembly according to claim 1, wherein the slot for the second pin in the second bushing is made of an elongated oval shape, being oriented along the bushing axis.

3. The ice auger handle attachment assembly according to claim 1, wherein the metallic section of the inner surface of the second bushing is made with an element that prevents longitudinal shift and rotation of the said section relative to the axis of the bushing.

4. The ice auger handle attachment assembly according to claim 3, wherein the element, which prevents the longitudinal shift and rotation of the metallic section of the inner surface of the second bushing relative to the axis of the bushing, is made in the form of a protrusion.

5. The ice auger handle attachment assembly according to claim 3, wherein the element, which prevents the longitudinal shift and rotation of the metallic section of the inner surface of the second bushing relative to the axis of the bushing, is made in the form of a recess.

6. The ice auger handle attachment assembly according to claim 1, wherein the fork-shaped lever is made of metal and at least partially comprises a shell of a polymeric material.

7. An ice auger comprising a handle and an auger conveyor, wherein the handle is movably attached to the auger conveyor by means of the attachment assembly according to claim 1.

8. The ice auger according to claim 7, wherein the ice auger comprises a helical blade made on the auger conveyor from its lower end to the middle part, a drill head attached to the auger conveyor at its lower end, and at least one cutting blade attached to the drill head.

9. The ice auger according to claim 8, wherein the drill head is attached to the auger conveyor at its lower end by means of a detachable connection.

10. The ice auger according to claim 8, wherein the drill head is connected to the auger conveyor at its lower end by means of a permanent connection.
